(19) United States
(12) Patent Application Publication
(10) Pub. No.: US 2004/0107293 A1
(43) Pub. Date: Jun. 3, 2004

(54) Program obtainment method and packet transmission apparatus

(75) Inventor: Hirotsugu Okura, Kaizu-gun (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/721,998

(22) Filed: Nov. 26, 2003

(30) Foreign Application Priority Data
Nov. 29, 2002 (JP) JP2002-346784

(51) Int. Cl. G06F 15/16

(52) U.S. Cl. 709/232

(57) ABSTRACT

A packet transmission apparatus for downloading a program is provided. A packet processor reads a packet from a data buffer and a program tag extractor extracts information from a tag in the packet, which indicates a location where a program is stored. A downloader downloads an individual program from the location and stores the program in a program storage. A program switch controls a program executor to execute a preliminary program while the individual program is being downloaded. When the download is completed, the program switch controls the program executor to switch over to the individual program. The packet executor executes the individual program and controls the packet transmission.

### BACKGROUND OF THE INVENTION

1. Field of the Invention

The present invention relates to an active network technology, and it particularly relates to a method for obtaining a program to be placed in a network node, and a packet transmission apparatus using the method.

2. Description of the Related Art

Since the use of broadband networks has been common among general users, network resource consuming services become popular, such as peer-to-peer real time communication using image and audio, a streaming distribution using video and so on. As a result, the users' awareness about quality of the network services has been raised and the users become very sensitive to quality degradation. Therefore, a guarantee of Quality of Service (QoS) has been strongly requested for the Internet that has offered best effort services. Besides personal computers, mobile phones and mobile terminals are commonly used as a new means for utilizing the networks, and therefore it is also necessary that a flexible service should be offered according to the type of communication of the terminals. In such situations, a network node such as a router, a switch, or the like has been expected not only to perform a simple packet transmission process but also to have a kind of intelligence in consideration of an application layer.

The terminal to access the networks can easily undergo a model change according to various needs of the users or a new network technology and the cycle of the model change becomes short. On the other hand, since guarantee of connectivity and compatibility with the old models are required in the case of a router or a switch and standardization is necessary for changing the specifications, it takes a long time to conform to a new technology. It is difficult to immediately conform to the requirements of a great variety of network services. As a technology by which the functions of the networks can be flexibly changed, a concept of an active network has been proposed, for instance, in the reference [1]. The active network can flexibly control the behavior of the network by locating a program in a network node. Since by adopting the mechanism of the active network, they can introduce new service functions into a network system at an early stage without spending time and costs for standardization, the industrial world as well as the academic have expected much of the active network.

In order to realize the active network, a program for performing a specific process on packets to be sent to the terminal is transmitted to a specific network node and the program is placed in the network node. The node in which such a specific program is placed is called an active node. There are two methods for placing a program in an active node: one method is to upload a program of necessity in the active node beforehand and another method is to attach a program as a part of packets to be sent to the terminal and thereby offer the program to the node.

According to the latter method by which the program is stored in the packets and offered, a packet processing cannot be performed until the program is placed in a node and the installation of the program is completed, therefore resulting in a delay in the stream transmission. According to the former method by which the program is uploaded beforehand, once a program is installed, the installed program is applied to the stream as soon as a transmission of stream data is initiated. However, in this case, the terminal or a server must install the necessary program to a node before the transmission of the stream data. Therefore, in any methods, it takes a time to install a program and a problem occurs such that the stream communication cannot start up or may be interrupted during the installation.

Related Art List:

[1] Miki Yamamoto, “A Survey of Active Network Technology”, IEICE Transactions on Communications, Vol. J84-B, No.8, pp.1401-1412, August 2001.

### SUMMARY OF THE INVENTION

The present invention has been made based on these considerations, and an object thereof is to provide a network technology which can place a program in a network node effectively.

According to one aspect of the present invention, a packet transmission apparatus is provided. The apparatus comprises an extraction unit which extracts information from a stream packet to be sent to a terminal, which indicates a location where an individual program for performing a specific process on the stream is stored; a download unit which downloads the individual program from the location; a storage which stores the downloaded individual program; and an execution unit which executes the individual program by incorporating the individual program into a packet processing on the stream.

The packet transmission apparatus may be a network node such as a router, a switch, a wireless access point, or the like, and the apparatus may have an environment for performing a specific packet processing by incorporating an individual program as well as performing a standard packet processing. The individual program performs a specific process on the stream packet according to a characteristic of the stream data or a connection type of the terminal receiving the stream. The specific process is, for instance, a packet priority control, QoS control, or the like, and it does not need to be a standardized process.

The storage may store the information, which indicates the location where the individual program is stored, in association with the individual program. In this case, the information indicating the location serves as an index for the individual program so that the individual program can be searched by using the information indicating the location as a key.

The storage may store a preliminary program and the preliminary program may be incorporated into the packet processing and executed until the download of the individual program is completed. The preliminary program performs a standardized process or a process that has been normalized to some extent, such as a packet transmission process, a protocol-based processing or the like.

According to another aspect of the present invention, a packet transmission apparatus is also provided. The apparatus comprises an extraction unit which extracts information from a stream packet to be sent to a terminal, which indicates a characteristic of the stream data; a download unit which searches and downloads an individual program suitable for the characteristic; a storage which stores the downloaded individual program; and an execution unit which executes the individual program by incorporating the individual program into a packet processing on the stream.

The information indicating the characteristic of the stream data may be information on a stream communication quality such as packet delay or delay jitter, information on a data type of the stream such as real-time continuous media, stored continuous media or non-real-time data, or the like. For each stream to be sent to a terminal, an individual program for performing a packet priority control, a communication bandwidth allocation control, or the like can be downloaded and utilized.

According to still another aspect of the present invention, a program obtainment method is provided. The method comprises extracting information from a stream packet to be sent to a terminal, which indicates a location where an individual program for performing a specific process on the stream is stored; performing a normal packet transmission processing on the stream while the individual program is being downloaded from the location; and performing a packet processing continuously by incorporating the individual program into the packet processing once the download of the individual program is completed.

According to still another aspect of the present invention, a program obtainment method is also provided. The method comprises extracting information from a stream packet to be sent to a terminal, which indicates a characteristic of the stream data; performing a normal packet transmission processing on the stream while the individual program suitable for the characteristic is being downloaded; and performing a packet processing continuously by incorporating the individual program into the packet processing once the download of the individual program is completed.

Moreover, any arbitrary replacement or substitution of the above-described structural components and the steps, expressions replaced or substituted in part or whole between a method and an apparatus as well as addition thereof, and expressions changed to a system, a computer program, a storage medium, a transmission medium or the like are all effective as and are encompassed by the present invention.

This summary of the invention does not necessarily describe all necessary features, so that the invention may also be a sub-combination of these described features.

### BRIEF DESCRIPTION OF THE DRAWINGS

FIG. 1 shows a structure of an active network according to an embodiment.

FIG. 2 is a block diagram of the packet transmission apparatus of FIG. 1.

FIG. 3 illustrates an example of a program tag in a packet.

FIGS. 4a to 4c illustrate another example of a program tag in a packet.

FIGS. 5a and 5b illustrate still another example of a program tag in a packet.

FIG. 6 illustrates how an individual program and its storing location are associated and stored in the program storage of FIG. 2.

FIG. 7 illustrates how an individual program and a stream characteristic are associated and stored in the program storage of FIG. 2.

FIG. 8 is a flowchart showing a procedure employed by the packet transmission apparatus of FIG. 2 for obtaining a program.

### DETAILED DESCRIPTION OF THE INVENTION

The invention will now be described by reference to the preferred embodiments. This does not intend to limit the scope of the present invention, but to exemplify the invention.

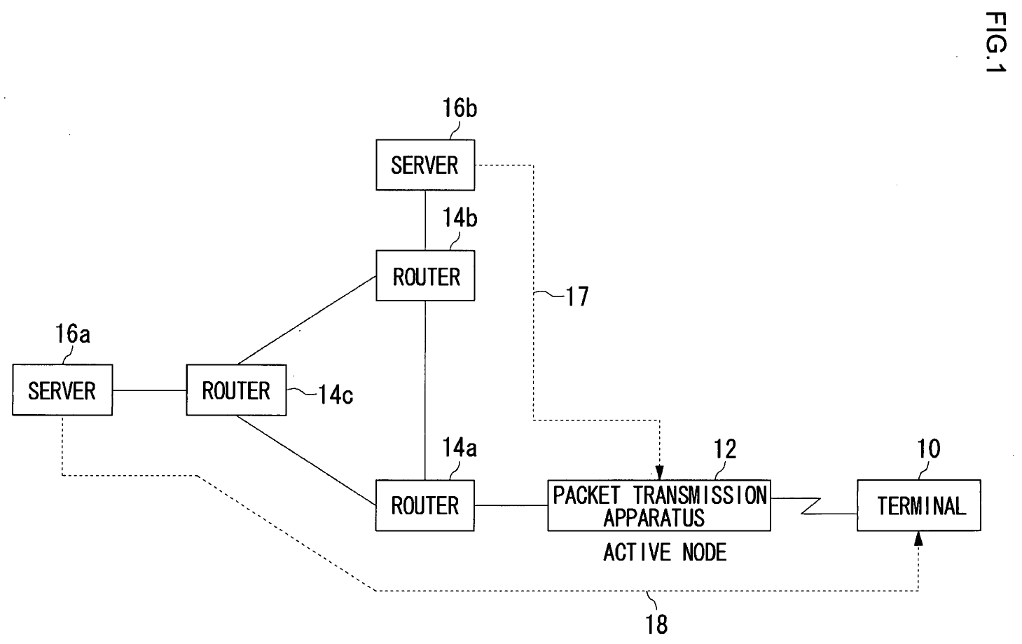

FIG. 1 shows a structure of an active network according to an embodiment. An access point that a terminal 10 connects with by wireless is an active node and a packet transmission apparatus 12 is provided on the node. Routers 14a to 14c (hereinafter generally called the router 14) are interconnected via a wired network. Servers 16a and 16b (hereinafter generally called the server 16) send stream data to the terminal 10 via a network and also send an individual program for processing the stream data according to the request from the packet transmission apparatus 12. The terminal 10 is, for instance, a personal computer, a portable electronic device such as a PDA (Personal Data Assistant), a mobile phone with data communication function, or the like.

The terminal 10 receives a stream 18 from the server 16a via the routers 14c, 14a and the packet transmission apparatus 12. The packet transmission apparatus 12 performs a process for transmitting the stream 18 as an active node. The packet transmission apparatus 12 receives an individual program 17 for performing a packet processing suitable for a characteristic of the stream from a storing location specified by the after-mentioned program tag, that is, the server 16b in this case, and then install the program.

Although the wireless access point is an active node in the case of FIG. 1, the router 14 may be an active node. In this case, the packet transmission apparatus 12 is provided on the router 14. The packet transmission apparatus 12 may be provided on a plurality of network nodes on the communication path from the router 14 to the terminal 10.

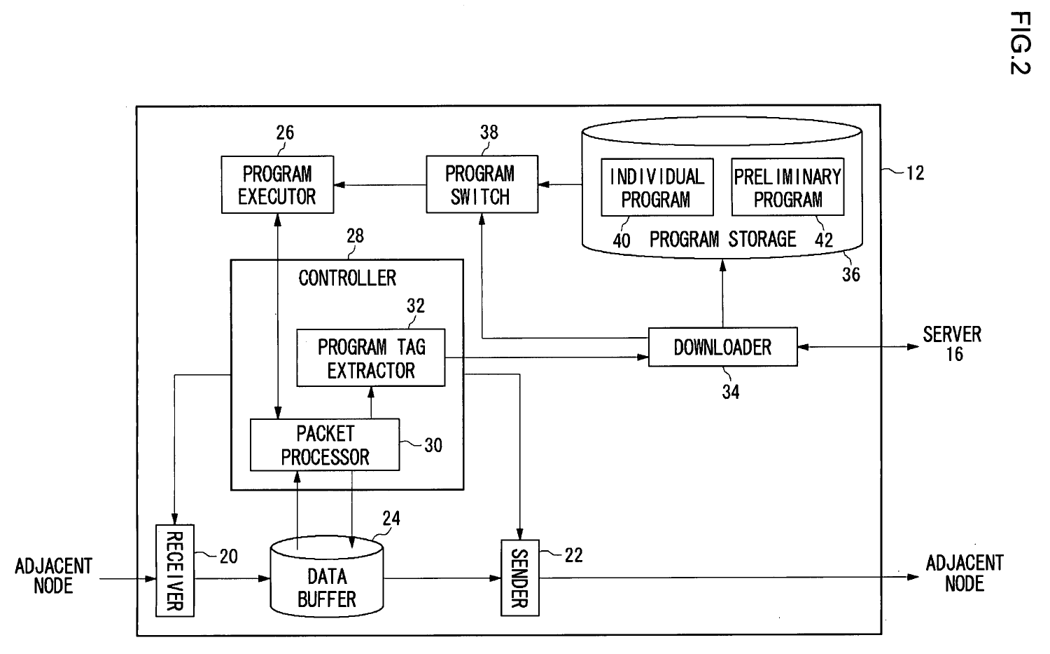

FIG. 2 is a block diagram of the packet transmission apparatus 12. This structure can be realized by hardware, such as a CPU in arbitrary computers, memory and other LSIs, or by software, such as a program or the like loaded in the memory, which has a packet processing function. In this figure, functions, which are realized by combinations of such hardware and software, are shown by blocks. It should be understood by those skilled in the art that these functional blocks can be realized by various modes such as hardware only, software only or a combination thereof.

A controller 28 controls a receiver 20 for receiving stream data from an adjacent node and a sender 22 for sending stream data to an adjacent node. The receiver 20 receives a packet from the adjacent node on the communication path of the stream data and stores it in a data buffer 24. A packet processor 30 in the controller 28 retrieves the packet from the data buffer 24 and performs a protocol-based processing. The packet processor 30 identifies a type of the received packet and if the packet is communication data, the packet processor 30 writes a send packet, for which a protocol-based processing has been performed, into the data buffer 24. The sender 22 forwards the send packet stored in the data buffer 24 to the adjacent node.

If the received packet contains a program tag, the packet processor 30 provides the program tag to a program tag extractor 32. The program tag extractor 32 analyzes the program tag and extracts information on the storing location of the program that is included in the tag, and then provides the information to a downloader 34. The information on the storing location is identification information of the server 16 storing an individual program 40 or a URL (uniform Resource Locator) that uniquely identifies the location of a file in the Internet.

On the basis of the information on the storing location, the downloader 34 requests the server 16 that stores the individual program 40 to transmit the individual program 40, and downloads the individual program 40 by a file transfer protocol or the like and then stores the program in a program storage 36.

The program tag may describe a characteristic of the stream, such as data type, a quality requirement, or the like. In this case, the downloader 34 searches an individual program 40 suitable for the characteristic and downloads it from an appropriate server 16. In order to search such an individual program 40, a program database may be provided on the server 16 or the packet transmission apparatus 12. In the case of searching and downloading the individual program 40, the individual program 40 may be downloaded from the location where the program can be downloaded in as short time as possible, in consideration of the network traffic and the processing load on the server 16.

The program storage 36 stores a preliminary program 42, which performs a standard packet processing, besides the individual program 40. The preliminary program 42 is a program for a basic packet transmission, while the individual program 40 offers an additional function for the packet processing, for instance, selective packet discard, traffic shaping, change in transfer rate and resolution of continuous media, or the like. The preliminary program 42 and the individual program 40 are utilized as a library.

A program switch 38 controls a program executor 26 to switch between the individual program 40 and the preliminary program 42 stored in the program storage 36 and execute the program. The program switch 38 controls the program executor 26 to execute the preliminary program 42 until the downloader 34 finishes downloading the individual program 40. When the downloader 34 completes the download of the individual program 40, on receiving from the downloader 34 a notification on the completion of the download, the program switch 38 controls the program executor 26 to switch over to executing the individual program 40. Furthermore, the program switch 38 may switch over between a plurality of the preliminary programs 42 or between a plurality of the individual programs 40 depending on the characteristic of the stream data.

The program executor 26 executes the individual program 40 or the preliminary program 42 as instructed by the program switch 38 and performs a priority control on the packet transmission processing by the packet processor 30. The program executor 26 may incorporate these programs into a part of the packet processing by the packet processor 30. In a protocol-based processing by the packet processor 30, the control may be switched over to the program executor 26 and the program may be executed therein. The packet, which the packet processor 30 has processed and on which the program executor 26 has performed the priority control or the like, is written to the data buffer 24 by the packet processor 30 and forwarded to the adjacent node by the sender 22.

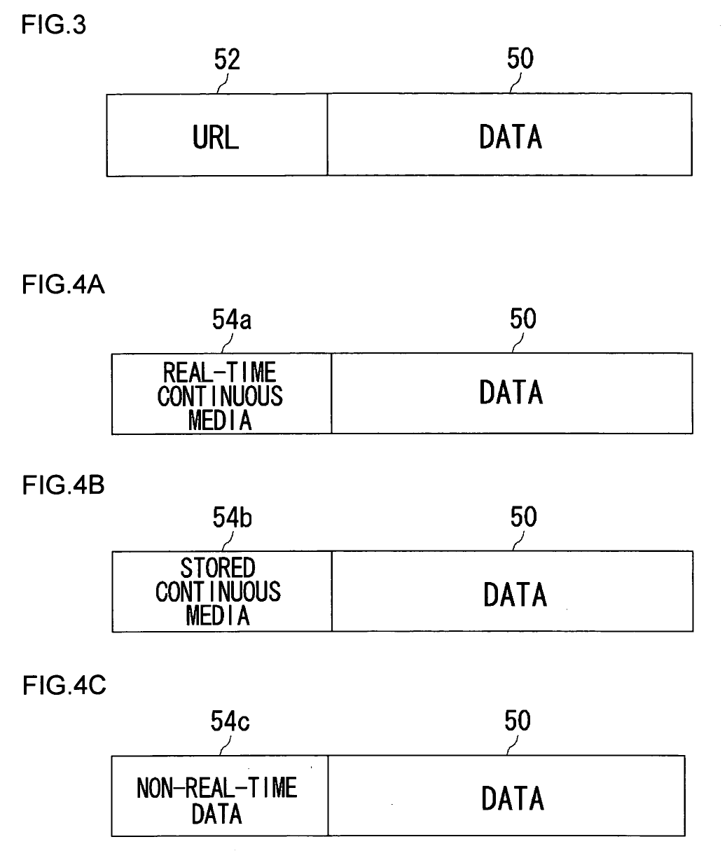

FIG. 3 illustrates a program tag in a packet. At the header of the packet, that is, prior to data 50, a program tag 52 containing information on the storing location of the individual program 40 is added. In this example, the URL of the individual program 40 is specified in the program tag 52.

FIGS. 4a to 4c explain another example of the program tag. In this example, the program tag does not contain the storing location of the individual program 40, but contains the information on the characteristic of the stream, which is used as a reference when the downloader 34 searches the individual program 40. In this example, a data type of the stream is specified in the program tag. In FIG. 4a, the attached program tag 54a indicates that the stream data is real-time continuous media. In FIG. 4b, the attached program tag 54b indicates that the stream data is stored continuous media. In FIG. 4c, the attached program tag 54c indicates that the stream data is non-real-time data.

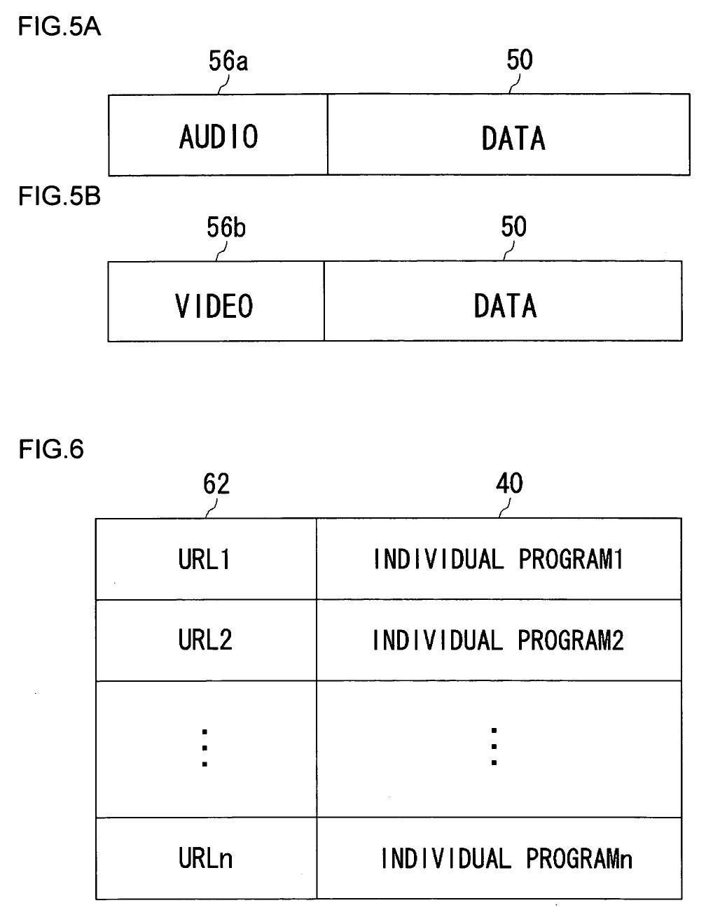

FIGS. 5a and 5b explain yet another example of the program tag. In this example, a media type of the stream is specified. In FIG. 5a the attached program tag 56a indicates that the stream data is audio, and in FIG. 5b the attached program tag 56b indicates that the stream data is video. In this case, the downloader 34 searches an individual program 40 suitable for the media type.

When the individual program 40 is stored in the program storage 36, the program tag can be stored in association with the individual program 40. FIG. 6 illustrates how the individual program 40 and the storing location 62 are associated and stored. The storing location 62 is associated with the individual program 40 as shown in the figure. Therefore the downloader 34 can search in the program storage 36 using the storing location extracted by the program tag extractor 32 as an index and check whether the corresponding individual program 40 has been already downloaded.

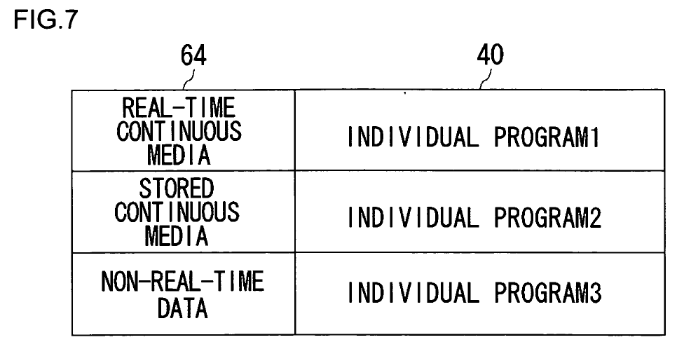

The same association can be made in the case where the characteristic of the stream is described in the program tag. FIG. 7 illustrates how the individual program 40 and the stream characteristic 64 are associated and stored. In this example, a different kind of individual program 40 is associated with each stream characteristic 64: real-time continuous media, stored continuous media, or non-real-time data. The downloader 34 can search in the program storage 36 using the stream characteristic extracted by the program tag extractor 32 as an index and check whether an individual program 40 suitable for the stream characteristic already exists in the program storage 36.

If the corresponding individual program 40 has been already stored in the program storage 36, the downloader 34 does not need to download the individual program 40 again except when the version of the program must be upgraded. In this case, the program executor 26 immediately executes the individual program 40 without executing the preliminary program 42.

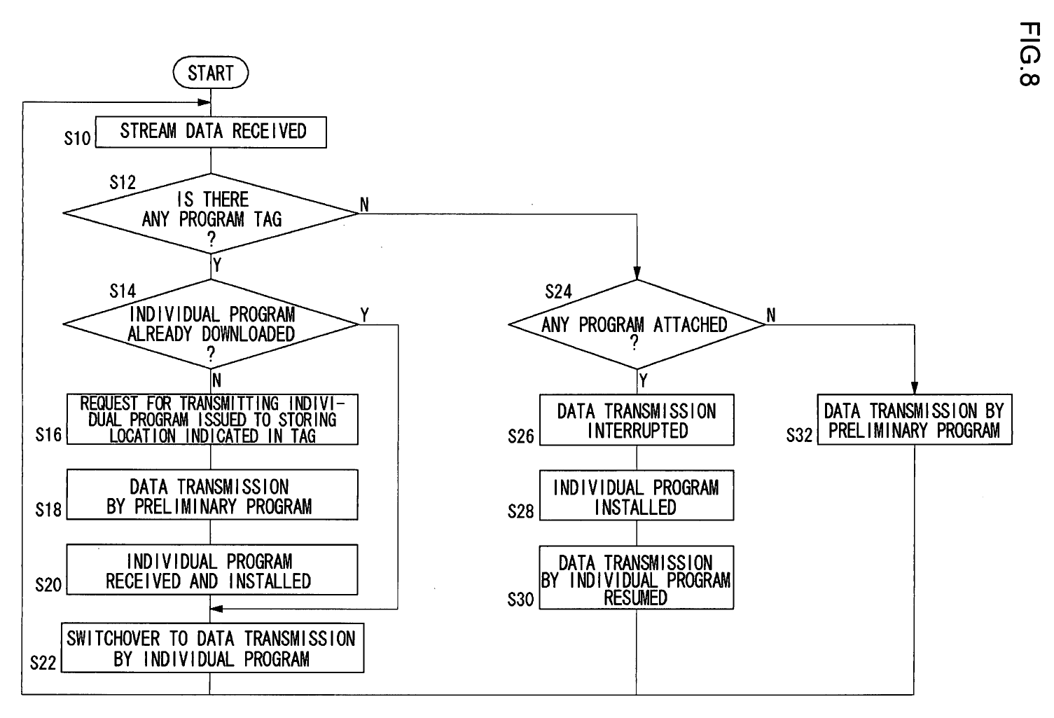

The program obtainment procedure by the packet transmission apparatus 12 according to the above-described configuration is now explained using a flowchart shown in FIG. 8. The stream transmission from the server 16 to the terminal 10 starts and the packet transmission apparatus 12 receives the stream data (S10). The packet processor 30 in the packet transmission apparatus 12 checks whether there is any program tag in the received packet (S12). If there is a program tag (Y of S12), the program extractor 32 extracts information on the storing location from the program tag and provides it to the downloader 34. The downloader 34 checks if the corresponding individual program 40 has been already downloaded and stored in the program storage 36 by using this storing location as an index (S14).

If the corresponding individual program 40 has not been downloaded (N of S14), the downloader 34 issues a request for transmitting the individual program 40 to the storing location indicated in the program tag (S16). The program switch 38 controls the program executor 26 to execute the preliminary program 42 while the individual program 40 is being downloaded and thereby the data transmission by the preliminary program 42 is performed on the packet processor 30 (S18). The downloader 34 finishes receiving the individual program 40 and the individual program 40 is installed (S20). On receiving the notification on completion of receiving the individual program 40, the program switch 38 controls the program executor 26 to switch over to the individual program 40 and the data transmission by the individual program 40 is performed on the packet processor 30 (S22).

At the step S14, if the corresponding individual program 40 has been already downloaded (Y of S14), the procedure goes to the step S22 without downloading the individual program 40, and the program switch 38 controls the program executor 26 to switch over immediately to the individual program 40 stored in the program storage 36 and the data transmission by the individual program 40 is performed from the start.

At the step S12, if there is no program tag in the packet (N of S12), it is checked whether any program is attached to the packet (S24). If the individual program 40 is attached to the packet, the packet transmission of the stream is interrupted temporarily (S26) and the individual program 40 is stored in the program storage 36 and then installed (S28). When the installation is completed, the program switch controls the program executor 26 to execute the individual program 40 and the data transmission by the individual program 40 is resumed in the packet processor 30 (S30).

At the step S24, if no program is attached to the packet (N of S24), the program switch 38 controls the program executor 26 to execute the preliminary program 42 and the data transmission by the preliminary program 42 is performed on the packet processor 30 (S32).

In the above procedure, the individual program 40 is downloaded from the storing location indicated in the program tag, however, if the characteristic of the stream data is described in the program tag, the individual program 40 suitable for the characteristic is searched and downloaded.

According to information on the terminal 10 that receives the stream data, the individual program 40 may be selected and the process of converting the packet may be performed. The information on the terminal 10 includes information on a connection type of the terminal 10 such as wireless or wired, information on a processing capacity of the terminal 10 such as memory performance and a receivable amount of data, information on a charge on the terminal 10 such as a charge for quantity of usage or a fixed charge, or the like.

For instance, for performing a packet encoding such as compression or encryption, a different individual program 40 corresponding to each encoding method is provided. If the processing capacity of the terminal 10 is low, the program switch 38 selects one individual program 40 that utilizes a simple encoding method in which a load for decoding is small. If the terminal 10 connects with the network by wireless, the program switch 38 selects one individual program 40 that utilizes an encoding method in which the data compression rate is high.

Moreover, if the processing capacity of the terminal 10 is low, for instance, when the stream data is sent to a mobile phone, the program executor 26 converts the media data to a low-resolution format so that the terminal 10 might not be excessively loaded. If the terminal 10 connects with the network by wireless, the program executor 26 reduces the frame rate so that the amount of data can be adjusted to the wireless communication bandwidth.

Furthermore, the individual program 40 with a different level of guaranteed QoS may be selected so that the service quality can be differentiated according to the charge on the stream communication. In addition, a different URL may be specified in the program tag according to the charge so that the individual program 40 with a different level of guaranteed QoS can be downloaded.

According to the present embodiment, as has been described, the packet transmission apparatus 12 can download and execute the individual program 40 for the active node without interrupting transferring the stream data to the terminal 10. For instance, in the stream communication of real-time continuous media, while the individual program 40 is being downloaded, a normal packet transmission is performed so that such a situation can be avoided that the packet transmission is interrupted resulting in considerable quality degradation. Since the individual program 40 is not directly attached to the packet to be sent, but the tag indicating the storing location of the individual program 40 is attached to the packet to be sent, it is effective especially when the size of the individual program 40 is large or when the communication requires real-timeliness.

Although the present invention has been described by way of exemplary embodiments, it should be understood that many changes and substitutions may be made by those skilled in the art without departing from the scope of the present invention which is defined by the appended claims. Some such alterations are stated as follows.

In the above explanation, the router or the access point performing the packet transmission is considered as an active node, however, the server offering stream data may become an active node. The stream distribution has been explained as an example, however, the present invention can be applied to a real-time two-way communication such as a TV conference, or a peer-to-peer communication between terminals. Moreover, in the above explanation, the individual program 40 is downloaded from the server 16 and installed in the active node, however, the individual program 40 may be transmitted from the terminal 10 to the active node.

What is claimed is:

1. A packet transmission apparatus comprising:
an extraction unit which extracts information from a stream packet to be sent to a terminal, which indicates a location where an individual program for performing a specific process on the stream is stored;
a download unit which downloads the individual program from the location;
a storage which stores the downloaded individual program; and
an execution unit which executes the individual program by incorporating the individual program into a packet processing on the stream.

2. The apparatus of claim 1, further comprising a switch unit which provides the execution unit with a switchover instruction to incorporate the individual program after the download of the individual program is completed, and wherein the execution unit performs a normal packet transmission processing on the stream until receiving the switchover instruction.

3. The apparatus of claim 2, wherein the storage stores a preliminary program and the switch unit provides the execution unit with a switchover instruction to incorporate the preliminary program until the download of the individual program is completed.

4. The apparatus of claim 1, wherein the storage stores the information, which indicates the location where the individual program is stored, in association with the individual program, and if the information extracted by the extraction unit, which indicates the location where the individual program is stored, has been already stored in the storage, the individual program is not downloaded once more and the packet processing is performed using the individual program stored in the storage.

5. A packet transmission apparatus comprising:
an extraction unit which extracts information from a stream packet to be sent to a terminal, which indicates a characteristic of the stream data;
a download unit which searches and downloads an individual program suitable for the characteristic;
a storage which stores the downloaded individual program; and
an execution unit which executes the individual program by incorporating the individual program into a packet processing on the stream.

6. The apparatus of claim 5, further comprising a switch unit which provides the execution unit with a switchover instruction to incorporate the individual program after the download of the individual program is completed, and wherein the execution unit performs a normal packet transmission processing on the stream until receiving the switchover instruction.

7. The apparatus of claim 6, wherein the storage stores a preliminary program and the switch unit provides the execution unit with a switchover instruction to incorporate the preliminary program until the download of the individual program is completed.

8. The apparatus of claim 5, wherein the storage stores the information, which indicates the characteristic of the stream data, in association with the individual program, and if the information extracted by the extraction unit, which indicates the characteristic of the stream data, has been already stored in the storage, a packet processing using the individual program stored in the storage is performed without downloading the individual program.

9. The apparatus of claim 5, further comprising a switch unit which selects from the storage an individual program for converting the packet in accordance with a processing capacity of the terminal, and provides the execution unit with a switchover instruction to incorporate the selected individual program.

10. The apparatus of claim 5, further comprising a switch unit which selects from the storage an individual program for converting the packet in accordance with a wireless communication quality if the terminal connects by wireless, and provides the execution unit with a switchover instruction to incorporate the selected individual program.

11. A program obtainment method comprising:
extracting information from a stream packet to be sent to a terminal, which indicates a location where an individual program for performing a specific process on the stream is stored;
performing a normal packet transmission processing on the stream while the individual program is being downloaded from the location; and
performing a packet processing continuously by incorporating the individual program into the packet processing once the download of the individual program is completed.

12. The method of claim 11, further comprising storing a preliminary program beforehand and performing the packet processing by incorporating the preliminary program until the download of the individual program is completed.

13. The method of claim 11, further comprising storing the information, which indicates the location where the individual program is stored, in association with the individual program, and wherein if the information extracted by the extraction unit, which indicates the location where the individual program is stored, has been already stored, the individual program is not downloaded once more and the packet processing is performed using the stored individual program.

14. A program obtainment method comprising:
extracting information from a stream packet to be sent to a terminal, which indicates a characteristic of the stream data;
performing a normal packet transmission processing on the stream while the individual program suitable for the characteristic is being downloaded; and
performing a packet processing continuously by incorporating the individual program into the packet processing once the download of the individual program is completed.

15. The method of claim 14, further comprising storing a preliminary program beforehand and performing the packet processing by incorporating the preliminary program until the download of the individual program is completed.

16. The method of claim 14, further comprising storing the information, which indicates the characteristic of the stream data, in association with the individual program, and wherein if the information extracted by the extraction unit, which indicates the characteristic of the stream data, has been already stored, the individual program is not downloaded once more and the packet processing is performed using the stored individual program.
